(19) United States
(12) Patent Application Publication
(10) Pub. No.: US 2025/0028047 A1
(43) Pub. Date: Jan. 23, 2025

(54) DETECTION OF HIDDEN OBJECT USING NON-LINE-OF-SIGHT (NLOS) IMAGING

(71) Applicant: HUAWEI TECHNOLOGIES CO., LTD., Shenzhen, Guangdong Province (CN)

(72) Inventor: Yingxuan Zhu, Addison, TX (US)

(21) Appl. No.: 18/585,862

(22) Filed: Feb. 23, 2024

Related U.S. Application Data
(63) Continuation of application No. PCT/US2021/048223, filed on Aug. 30, 2021.

(51) Int. Cl. G01S 17/46; B60W 30/09; B60W 30/095; G01S 7/48; G01S 17/89; G01S 17/931

(52) U.S. Cl. CPC G01S 17/46; B60W 30/09; B60W 30/0956; G01S 7/4802; G01S 17/89; G01S 17/931; B60W 2554/80

(57) ABSTRACT

A method of detecting hidden objects in a dynamic environment of a main object. In an embodiment, the method is implemented by a main object. The main object selects a surface object in the dynamic environment to reflect a light signal. The main object transmits a light signal from the main object to the surface object to obtain data based on a reflection of the light signal off the surface object. The main object analyzes the data to detect a hidden object that is not directly in the line of sight of the main object.

### CROSS-REFERENCE TO RELATED APPLICATIONS

This application is a continuation of International Patent Application No. PCT/US2021/048223 filed on Aug. 30, 2021, by Futurewei Technologies, Inc., and titled “Detection of Hidden Object Using Non-Line-Of-Sight (NLOS) Imaging,” which is hereby incorporated by reference in its entirety.

### TECHNICAL FIELD

The present disclosure is generally related to perception systems and methods, and specifically to systems and methods for detecting a hidden object using non-line-of-sight (NLOS) imaging.

### BACKGROUND

Conventional sensor systems detect directly visible objects. NLOS imaging detects objects that are partially or fully occluded from direct view (i.e., a hidden object) by analyzing indirect diffuse reflections off a secondary relay surface. NLOS imaging enables new capabilities in a wide range of applications including autonomous vehicle navigation.

### SUMMARY

A first aspect relates to a method of detecting hidden objects in a dynamic environment of a main object. In an embodiment, the method is implemented by the main object. The main object selects a surface object in the dynamic environment to reflect a light signal. The main object transmits a light signal from the main object to the surface object to obtain data based on a reflection of the light signal off the surface object. The main object analyzes the data to detect a hidden object that is not directly in the line of sight of the main object.

Optionally, in a first implementation according to the first aspect, the surface object is a static object.

Optionally, in a second implementation according to the first aspect or any preceding implementation thereof, the surface object is a moving object.

Optionally, in a third implementation according to the first aspect or any preceding implementation thereof, the main object is a static object.

Optionally, in a fourth implementation according to the first aspect or any preceding implementation thereof, the main object is a moving object.

Optionally, in a fifth implementation according to the first aspect or any preceding implementation thereof, the hidden object is a static object.

Optionally, in a sixth implementation according to the first aspect or any preceding implementation thereof, the hidden object is a moving object.

Optionally, in a seventh implementation according to the first aspect or any preceding implementation thereof, the method further includes tracking a location of the surface object relative to the main object.

Optionally, in an eighth implementation according to the first aspect or any preceding implementation thereof, the method further includes establishing direct communication with the hidden object.

Optionally, in a ninth implementation according to the first aspect or any preceding implementation thereof, selecting the surface object includes determining a surface object detection region; removing objects that are not within the surface object detection region; identifying potential surface objects within the surface object detection region; and selecting the surface object from the potential surface objects.

Optionally, in a tenth implementation according to the first aspect or any preceding implementation thereof, selecting the surface object includes determining a criteria score for each of a plurality of criteria for each of a plurality of surface objects; determining a total score based on the criteria score for each of the plurality of criteria for each of the plurality of surface objects; and selecting the surface object from the plurality of surface objects based on the total score of each of the plurality of surface objects.

Optionally, in an eleventh implementation according to the first aspect or any preceding implementation thereof, the plurality of criteria for each of a plurality of surface objects includes a brightness of the surface object; a flatness of the surface object; a velocity of the surface object; a size of the surface object, an angle between surface norm and light reflected from the surface, and a distance between main object and surface object.

Optionally, in a twelfth implementation according to the first aspect or any preceding implementation thereof, the method further includes tracking the location of the surface object.

Optionally, in a thirteenth implementation according to the first aspect or any preceding implementation thereof, tracking the location of the surface object the method further includes receiving location information of the surface object from the surface object.

Optionally, in a fourteenth implementation according to the first aspect or any preceding implementation thereof, the method further includes tracking the hidden object.

Optionally, in a fifteenth implementation according to the first aspect or any preceding implementation thereof, tracking the hidden object includes determining whether the hidden object is moving.

Optionally, in a sixteenth implementation according to the first aspect or any preceding implementation thereof, tracking the hidden object includes determining whether the hidden object is moving towards the main object.

Optionally, in a seventeenth implementation according to the first aspect or any preceding implementation thereof, the method includes altering at least one of a speed and/or course of the main object to avoid the hidden object.

Optionally, in an eighteenth implementation according to the first aspect or any preceding implementation thereof, the method further includes providing a warning or signal to the main object to avoid the hidden object.

A second aspect relates to a method of selecting a surface object in a dynamic environment. The method is implemented by a main object to detect a hidden object that is not directly in the line of sight of the main object. The main object analyzes a scene depicting an environment of the main object. The main object determines a surface object detection region within the scene. The main object selects a surface object within the surface object detection region.

Optionally, in a first implementation according to the second aspect, the method further includes removing objects that are not within the surface object detection region.

Optionally, in a second implementation according to the second aspect or any preceding implementation thereof, determining a surface object detection region includes estimating an area where the hidden object may be located.

Optionally, in a third implementation according to the second aspect or any preceding implementation thereof, selecting a surface object within the surface object detection region includes determining a criteria score for each of a plurality of criteria for each of a plurality of surface objects in the surface object detection region; determining a total score based on the criteria score for each of the plurality of criteria for each of the plurality of surface objects in the surface object detection region; and selecting the surface object from the plurality of surface objects in the surface object detection region based on the total score of each of the plurality of surface objects in the surface object detection region.

Optionally, in a fourth implementation according to the second aspect or any preceding implementation thereof, the plurality of criteria for each of a plurality of surface objects includes a brightness of the surface object; a flatness of the surface object; a velocity of the surface object; a size of the surface object, a distance the surface object is from the main object, and an angle between surface norm and light reflected from the surface.

A third aspect relates to a system configured to detect hidden objects in a dynamic environment. The system includes a memory storing instructions; a processor coupled to the memory, the processor configured to execute the instructions to cause the network node to: select a surface object in the dynamic environment of a main object to reflect a light signal; transmitting the light signal from the main object to the surface object to obtain data based on a reflection of the light signal off the surface object; and analyze the data to detect a hidden object that is not directly in the line of sight of the main object.

Optionally, in a first implementation according to the third aspect, the surface object is a static object.

Optionally, in a second implementation according to the third aspect or any preceding implementation thereof, the surface object is a moving object.

Optionally, in a third implementation according to the third aspect or any preceding implementation thereof, the main object is a static object.

Optionally, in a fourth implementation according to the third aspect or any preceding implementation thereof, the main object is a moving object.

Optionally, in a fifth implementation according to the third aspect or any preceding implementation thereof, the hidden object is a static object.

Optionally, in a sixth implementation according to the third aspect or any preceding implementation thereof, the hidden object is a moving object.

Optionally, in a seventh implementation according to the third aspect or any preceding implementation thereof, the processor further configured to execute the instructions to track a location of the surface object relative to the main object.

Optionally, in an eighth implementation according to the third aspect or any preceding implementation thereof, the processor further configured to execute the instructions to establish direct communication with the hidden object.

Optionally, in a ninth implementation according to the third aspect or any preceding implementation thereof, selecting the surface object includes: determining a surface object detection region; removing objects that are not within the surface object detection region; identifying potential surface objects within the surface object detection region; and selecting the surface object from the potential surface objects.

Optionally, in a tenth implementation according to the third aspect or any preceding implementation thereof, selecting the surface object includes: determining a criteria score for each of a plurality of criteria for each of a plurality of surface objects; determining a total score based on the criteria score for each of the plurality of criteria for each of the plurality of surface objects; and selecting the surface object from the plurality of surface objects based on the total score of each of the plurality of surface objects.

Optionally, in an eleventh implementation according to the third aspect or any preceding implementation thereof, the plurality of criteria for each of a plurality of surface objects includes a brightness of the surface object; a flatness of the surface object; a velocity of the surface object; a size of the surface object, an angle between surface norm and light reflected from the surface, and a distance between main object and surface object.

Optionally, in a twelfth implementation according to the third aspect or any preceding implementation thereof, the processor further configured to execute the instructions to track the location of the surface object.

Optionally, in a thirteenth implementation according to the third aspect or any preceding implementation thereof, tracking the location of the surface object includes receiving location information of the surface object from the surface object.

Optionally, in a fourteenth implementation according to the third aspect or any preceding implementation thereof, the processor further configured to execute the instructions to track the hidden object.

Optionally, in a fifteenth implementation according to the third aspect or any preceding implementation thereof, tracking the hidden object includes determining whether the hidden object is moving.

Optionally, in a sixteenth implementation according to the third aspect or any preceding implementation thereof, tracking the hidden object includes determining whether the hidden object is moving towards the main object.

Optionally, in a seventeenth implementation according to the third aspect or any preceding implementation thereof, the processor further configured to execute the instructions to provide a warning or signal to the main object to avoid the hidden object.

Optionally, in an eighteenth implementation according to the third aspect or any preceding implementation thereof, the processor further configured to execute the instructions to alter a speed of the main object to avoid the hidden object.

Optionally, in a nineteenth implementation according to the third aspect or any preceding implementation thereof, the processor further configured to execute the instructions to alter a course of the main object to avoid the hidden object.

A fourth aspect relates to a system configured to select a surface object in a dynamic environment for detecting a hidden object. The system includes a memory storing instructions; a processor coupled to the memory, the processor configured to execute the instructions to cause the network node to: analyze a scene depicting an environment of a main object; determine a surface object detection region within the scene; and select a surface object within the surface object detection region.

Optionally, in a first implementation according to the fourth aspect, the processor further configured to execute the instructions to remove objects that are not within the surface object detection region.

Optionally, in a second implementation according to the fourth aspect or any preceding implementation thereof, determining a surface object detection region includes estimating an area where the hidden object may be located.

Optionally, in a third implementation according to the fourth aspect or any preceding implementation thereof, selecting a surface object within the surface object detection region includes: determining a criteria score for each of a plurality of criteria for each of a plurality of surface objects in the surface object detection region; determining a total score based on the criteria score for each of the plurality of criteria for each of the plurality of surface objects in the surface object detection region; and selecting the surface object from the plurality of surface objects in the surface object detection region based on the total score of each of the plurality of surface objects in the surface object detection region.

Optionally, in a fourth implementation according to the fourth aspect or any preceding implementation thereof, the plurality of criteria for each of a plurality of surface objects includes a brightness of the surface object; a flatness of the surface object; a velocity of the surface object; a size of the surface object, a distance the surface object is from the main object, and an angle between surface norm and light reflected from the surface.

For the purpose of clarity, any one of the foregoing implementation forms may be combined with any one or more of the other foregoing implementations to create a new embodiment within the scope of the present disclosure. These embodiments and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIGS. 1A-1C are schematic diagrams illustrating detection of a NLOS object in accordance with an embodiment of the present disclosure.

FIG. 2 is a flowchart illustrating a process for selecting a surface object in accordance with an embodiment of the present disclosure.

FIG. 3 is a schematic diagram illustrating a surface object detection region in accordance with an embodiment of the present disclosure.

FIG. 4 is a flowchart illustrating a process for tracking a selected surface object in accordance with an embodiment of the present disclosure.

FIG. 5 is a schematic diagram illustrating detection of a NLOS object in accordance with an embodiment of the present disclosure.

FIG. 6 is a flowchart illustrating a process for tracking a hidden object in accordance with an embodiment of the present disclosure.

FIG. 7 is a schematic diagram illustrating a system in accordance with an embodiment of the present disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

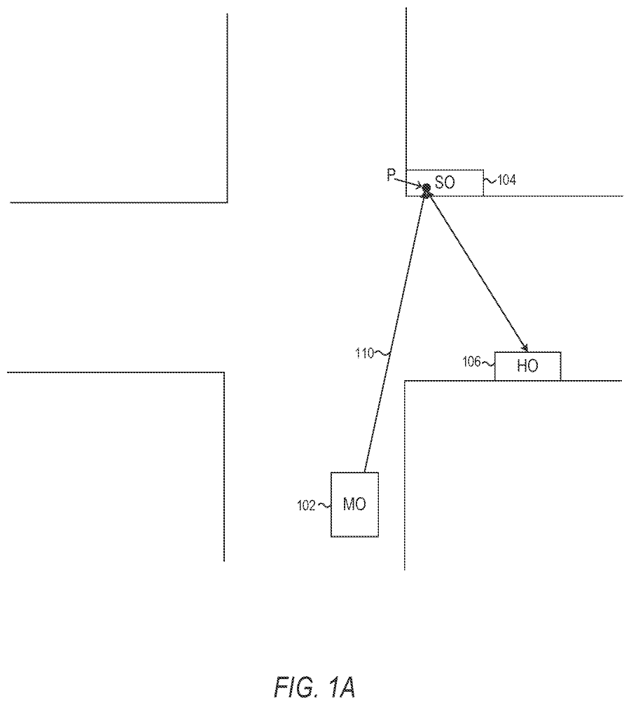

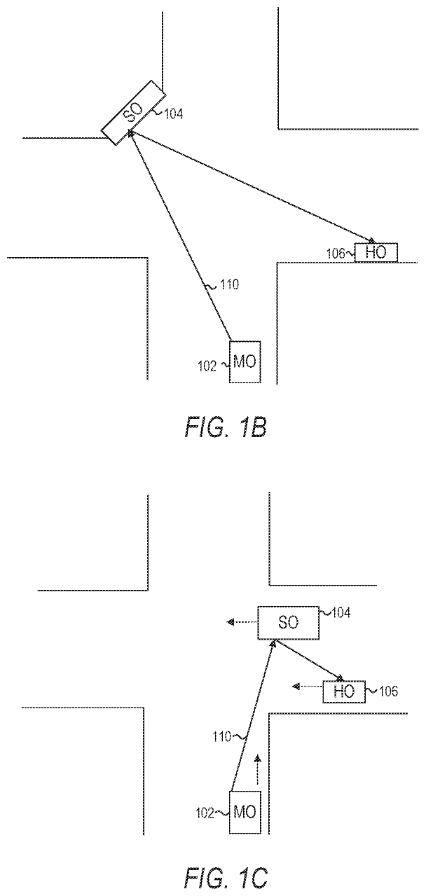

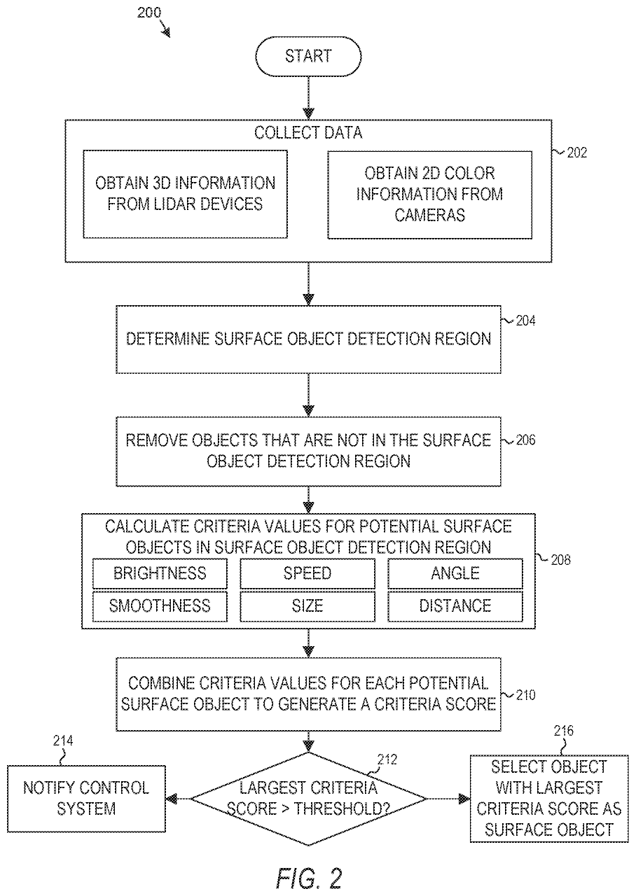

FIG. 1A is a schematic diagram illustrating detection of a NLOS object in accordance with an embodiment of the present disclosure. NLOS imaging analyzes light scattered from surface(s) along indirect paths and reconstructs the shape of objects outside the direct line of sight of a main object (MO) 102. The MO 102 may be any type of object or device (e.g., a vehicle, person, drone, robot, system, etc.) that may benefit from the detection of NLOS objects in a dynamic environment (e.g., to avoid a collision or other consequences). In an embodiment, the MO 102 includes a perception system comprising one or more object detection devices such as, but not limited to, a laser, sensor/photodetector, a camera, and/or a LiDAR device. In an embodiment, to detect a hidden object (HO) 106, the MO 102 uses the object detection devices to transmit (e.g., from a pulsed laser) light (e.g., light 110) from the MO 102 to a surface object (SO) 104 at a particular point (P) on the SO 104. The SO 104 is an object whose surface reflects light. Almost all surfaces will reflect light to some degree. Thus, the SO 104 can be any type of object that the perception system determines to be suitable, as described in FIG. 2, for use as a surface object to detect NLOS hidden objects. As shown in FIG. 1A, the light 110 from SO 104 indirectly illuminates the HO 106. The HO 106 reflects some of the light 110 back to point P of the SO 104. The perception system of the MO 102 uses a sensor to detect the light 110 reflected back to point P on the SO 104. The sensor can measure the arrival times of millions of photons of light and plot the data in a histogram (i.e., a graph). The histogram can include a direct light response time and an indirect light response time. The direct light response time is the time it takes for the direct light from the MO 102 to reflect off the SO 104 at point P. The indirect light response time is the time is takes for the indirect light reflecting off the HO 106 to reach the SO 104 at point P. The difference between the direct light response time and the indirect light response time represents the distance of the HO 106 from point P of the SO 104. To determine the shape of the HO 106, this process is repeated at various different points on the SO 104. By acquiring these timing measurements for different positions on the SO 104, the shape of the HO 106 can be reconstructed using various methods such as, but not limited to, using a convolution filtering algorithm, full linear reconstruction, filtered back projection (FBP), light cone transform (LCT), and Directional LCT (Determining-LCT). This approach is referred to transient-based imaging (i.e., based on time-of-flight of reflected light).

Apart from transient-based imaging, NLOS imaging for detecting HO 106 can be based on speckle imaging, incoherent intensity measurements, passive sensing, and/or acoustic imaging techniques. Although there are several NLOS imaging methodologies, these approaches are typically applied in a laboratorial environment, where the surface object (e.g., a wall) is predefined, which is not the case in a dynamic environment (e.g., real-world street environment). To be able to apply the NLOS imaging to a dynamic environment, the disclosed embodiments provide various systems and methods for identifying, selecting, and tracking a suitable surface object in a dynamic environment for NLOS imaging to detect hidden objects.

FIG. 1B and FIG. 1C illustrate alternative examples of the location of SO 104 and the HO 106 in accordance with an embodiment of the present disclosure. As shown in FIG. 1B, the SO 104 can be located on the northwest corner of the intersection as opposed to the northeast corner of the intersection as illustrated in FIG. 1A. As another possibility, the SO 104 may be a moving object such as a vehicle, and/or the HO 106 may also be a moving object as shown in FIG. 1C.

FIG. 2 is a flowchart illustrating a process 200 for selecting a surface object in accordance with an embodiment of the present disclosure. The process 200 is performed by a host system installed on a main object (e.g., the main object 102 of FIG. 1A). During the process 200, the main object measures criteria of objects in a scene depicting the dynamic environment of the main object and selects an optimal surface object in the dynamic environment for light reflection for detecting a hidden object.

The process 200 begins, at step 202, with the main object collecting information on the environment of the main object using a perception system of the main object. The perception system may include one or more object detection devices such LiDAR devices and one or more cameras to collect the information. In an embodiment, the process 200 obtains three-dimensional (3D) information from using the LiDAR devices, and obtains 2D color information using the one or more cameras. Using the information collected on the environment around the main object, the main object constructs a digital scene of the real environment around the main object.

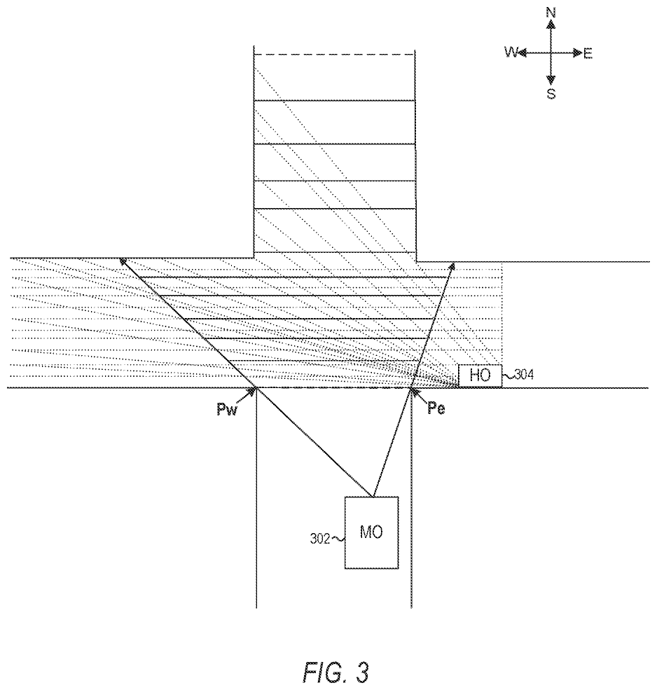

At step 204, the main object determines a surface object detection region (i.e., a region to detect a surface object for use in detecting hidden objects). In an embodiment, the surface object detection region is based on the location or line of sight of the main object and the location or line of sight of a potential hidden object. Otherwise stated, the surface object detection region where a surface object can be used for detecting a hidden object has to be within the line of sight of both the main object and any potential hidden object. An example of a surface object detection region is illustrated in FIG. 3.

In an embodiment, at step 206, the main object removes all objects identified by the LiDAR and visible light camera that are not located within the surface object detection region from consideration as surface object candidates. The objects are removed in order to reduce computation and processing time. For example, when the main object is approaching an intersection, any object not beyond the intersection cannot reflect hidden objects beyond the intersection. Therefore, these objects can be removed from the list of surface object candidates. As an example, in an embodiment, points at the east and west corners of an intersection are represented as pₑ=(xₑ, yₑ, zₑ) and p_{w}=(x_{w}, y_{w}, z_{w}), respectively. In addition, a point on the ground (g) located between pₑ and P_{w} is represented as p_{g}=(x_{g}, y_{g}, z_{g}). Assuming pₑ, p_{w}, and p_{g} are not in the same line, the plane through these three points can be presented as:

$$f ( x , y , z ) = [ \begin{matrix}x - {x}_{g} & y - {y}_{g} & z - {z}_{g} \\ {x}_{e} - {x}_{g} & {y}_{e} - {y}_{g} & {z}_{e} - {z}_{g} \\ {x}_{w} - {x}_{g} & {y}_{w} - {y}_{g} & {z}_{w} - {z}_{g}\end{matrix} ] = 0$$

Using the above equations, the main object can determine whether an object or point p is within the surface object detection region (i.e., what side of the plane the point p is located on) based on the location of the main object. For example, let p_{MO}=(x_{MO}, y_{MO}, z_{MO}) represent a point indicating the location of a main object. When f(x_{MO}, y_{MO}, z_{MO})>0, then objects at points p=(x, y, z) that have f(x, y, z)≥0 are also on the same side of the plane as the main object (e.g., on the south side of the plane through points pₑ, p_{w}, and p_{g}) and can be removed from consideration as they are not within the surface object detection region. Similarly, when f(x_{MO}, y_{MO}, z_{MO})<0, then objects at points p=(x, y, z) that have f(x, y, z)≤0 are on the same side of the plane as the main object and can be removed from consideration as they are not within the surface object detection region.

At step 208, for each object in the surface object detection region, the main object calculates a plurality of criteria values for selecting one or more of the objects as a surface object for detecting hidden objects (i.e., objects not within the line of sight of the main object). Non-limiting examples of criteria can include, but are not limited to, size, shape, smoothness, color, brightness, angle, distance, and stability/velocity of the object. For instance, all else being equal, a light color surface reflects a higher percentage of light than a dark color surface, and a smooth or flat surface has a higher percentage of diffusely reflected light than a coarse surface. In an embodiment, even though a surface with multiple colors can be smooth, a non-multicolor light color surface is preferred.

In an embodiment, the main object determines the flatness of an object using an intensity histogram. The intensity histogram is a graph showing the number of pixels in an image at each different intensity value found in that image. In an embodiment, for an 8-bit grayscale image there are 256 different possible intensities. For color images, either individual histograms of red, green, and blue channels can be taken, or a 3D histogram can be produced. The 3D histogram includes three axes representing the red, blue, and green channels, and a brightness at each point representing the pixel count. In an embodiment, the intensity histogram of a light-color smooth surface has pixel intensity values that are not diversified, but instead concentrate on a few values (i.e., entropy of surface color will be relatively small). Basically, when a bright object is smooth, the intensity histogram of the object will have values concentrating on large intensity values. On the other hand, when the object is not flat, the intensity values evenly distribute over the histogram. In an embodiment, the flatness (F) of an object is determined as follows:

$$F = - {\sum }_{i} h ( i ) ln h ( i )$$

where h(i) is the probability of intensity value i, which is obtained from a histogram.

In an embodiment, the brightness of an object can be measured by average luminance Lᵤ or luma Lₐ of the object as shown below.

$${L}_{u} = 0.2126 r + 0.7152 g + 0.0722 b ,$$

$${L}_{a} = 0.299 r + 0.587 g + 0.114 b$$

where r, g, and b are intensity values representing red, green, and blue, respectively.

In an embodiment, a big stable object is preferred over a small non-stable object. In an embodiment, the size S of an object is measured by the number of pixels or voxels that an object comprises in an image. A voxel represents a value on a regular grid in 3D space.

Additionally, in an embodiment, another criterion to consider is the angle α between the surface norm and the light reflected from the surface. In an embodiment, the angle a depends on the characteristics of a surface and is in proportion to an angle β between the surface norm and the incoming light. In an embodiment, an angle criterion A, which is relative to α, is represented by the cosine value of β, i.e., A=cos β, which is determined by the locations of the main object and the surface object.

In an embodiment, the speed or velocity (V) of an object can be measured as follow:

$$V = pv * fr * rs$$

where pv is the pixel velocity in pixel per frame of a video, fr is the frame rate in frame per second, and rs is the resolution in meter per pixel.

As for distance, when the travel distance of light increases, the light energy decreases. For instance, all else being equal, a reflecting light from a surface object close to a main object has more energy than a reflecting light from a surface object far away from the main object. In an embodiment, the distance between the main object and a surface object can be measured using the data from LiDAR.

In an embodiment, at step 210, the main object combines the criteria values for each potential surface object in the surface object detection region to generate a criteria score for each of the potential surface objects. For example, in an embodiment, let w_{b}, w_{f}, wᵥ, wₛ, w_{A}, and w_{D}, be the weights for brightness, flatness, moving speed, surface, angle, and distance respectively. Other criteria can also be included in the criteria score. The larger the weight, the more important the criterion is to the selection of the surface object. In an embodiment, the overall selection or criteria score (C) is calculated as follow: C=w_{b}B+w_{f}F+wᵥV+wₛS+w_{A}A+w_{D}D.

In an embodiment, an empirical threshold value can be used to avoid selecting an object with low overall criteria score C as a surface object. Thus, in an embodiment, the main object at step 212, determines whether the largest overall criteria score C among the potential surface objects in the surface object detection region is greater than a predetermined threshold value. When the largest overall criteria score C among the potential surface objects is less than the predetermined threshold value (i.e., there is no object that can reach the threshold value), the main object, at step 214, notifies a control system, and the control system can send out signals to warn the person/driver that potential undetectable hidden objects may be around.

When the largest overall criteria score C among the potential surface objects is greater than the predetermined threshold value, the main object, at step 216, selects the object with the largest C as the surface object for use in detecting hidden objects (e.g., SO= [symbol] (Cₖ), where k is the index of an object). Thus, using various criteria, the main object uses the process 200 to identify the best object (e.g., wall of a building or store, a street sign, a billboard, a side of a parked or moving vehicle, etc.) within the surface object detection region for use as a surface object.

FIG. 3 is a schematic diagram illustrating a surface object detection region in accordance with an embodiment of the present disclosure. As shown in FIG. 3, a main object 302, traveling north, is approaching an intersection. In the depicted embodiment, assume the main object 302 is not able to see a hidden object (HO) 304 due to the occlusion of the street corners (i.e., the corners completely block hidden object 304 from main object 302). The hidden object 304 can be any type of object such as, but not limited to, a vehicle, a bicyclist, or a pedestrian (e.g., someone jogging). The hidden object 304 can be a stationary object or an object in motion. As discussed above, in order for light from main object 302 to detect the hidden object 304, a surface object has to be located within a surface object detection region that enables a line of sight to both the main object and the hidden object 304. For light from a surface object to reach the hidden object 304, the surface object has to be beyond the street corners (Pe and Pw are the points at the east corner and west corner, respectively). Therefore, as shown in FIG. 3, the dark solid horizontal lines indicate the region within the line of sight of the main object 302 and past the street corners. Note that the region is bounded by the corners Pw and Pe. Although the location of the hidden object 304 is unknown, the potential locations of various hidden objects can be calculated or approximated. For example, when an assumption is made that there is a hidden object 304 in the location as depicted in FIG. 3, the line-of-sight range for the hidden object 304 can be determined as shown by the dashed lines. Thus, the area where the line of sight of the main object 302 (solid horizontal lines) intersects with the line of sight of the hidden object 304 (dashed lines) is the surface object detection region where a surface object can be used by the main object 302 to detect the hidden object 304.

As stated above, a selected surface object can be a static object or a moving object. Even when the surface object is a static object, the main object may be moving. Therefore, the static object has a relative speed with respect to the main object. Thus, in an embodiment, a selected surface object is tracked. A goal of tracking the surface object is to maintain a relatively stable position between the main object and the surface object (i.e., so that the main object does not move out of the line of sight to the surface object or vice versa). By tracking the surface object, the speed and location of the surface object is known to the main object and the accuracy of detecting a hidden object can be improved.

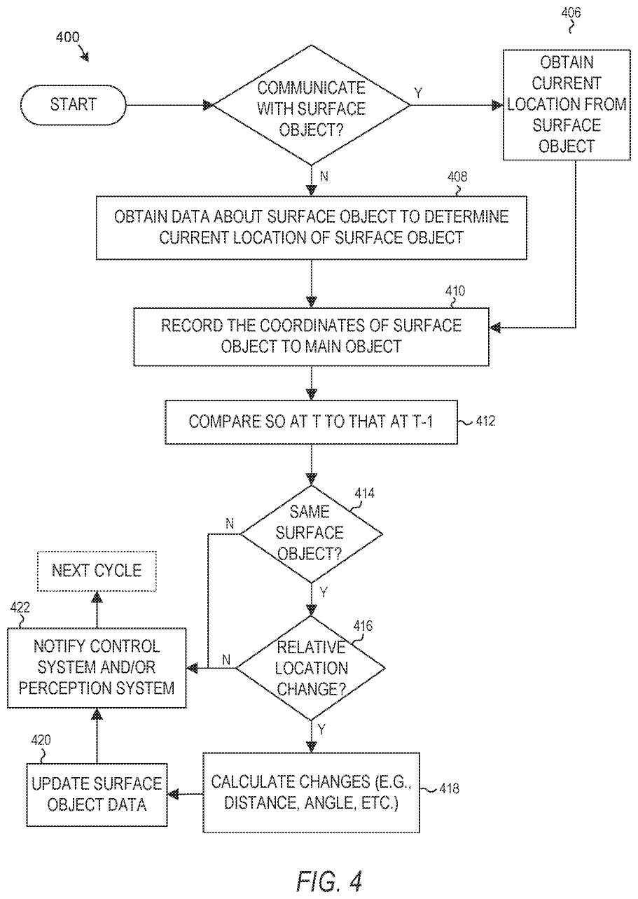

FIG. 4 is a flowchart illustrating a process 400 for tracking a selected surface object in accordance with an embodiment of the present disclosure. The process 400 is performed by a host system installed on a main object. In an embodiment, the simplest way to track a selected surface object is obtain location information directly from the selected surface object. For example, a selected surface object may be equipped with a Global Positioning System (GPS) device and other communication devices, such as, but not limited to, Wi-Fi® or near-field wireless communication devices (e.g., the selected surface object is an intelligent connected vehicle or some other Internet of things (IOT) device such as a connected billboard display or street sign). Therefore, in an embodiment, at step 402, the main object determines whether the host system can communicate directly with the selected surface object. When the host system can communicate directly with the selected surface object, at step 406, the main object obtains the surface object information (e.g., object type, exact size, etc.) and location directly from the surface object to track the surface object (and may also optionally obtain the surface objects current and future velocity or path of movement). When the host system cannot communicate directly with the selected surface object, at step 408 the main object uses the perception system (e.g., the LiDAR device and/or cameras) to identify the selected surface object and determine the current location of the selected surface object. At step 410, the main object records the coordinates (i.e., location) of the selected surface object relative to the location of the main object at time t. The main object then compares the location of the surface object at time t to the location of the surface object at time t−1 to determine whether the surface object is moving at step 412.

In an embodiment, the main object, at step 414, verifies that the surface object that is being tracked is the same surface object that was previously selected (or same surface object detected in the last detection cycle) using the obtained surface object information (e.g., based on size, flatness, distance, etc.). In an embodiment, when the surface object information indicates that the surface object is not the same surface object as previously tracked, the main object, at step 422, notifies a control system and/or perception system that the selected surface object is currently not being tracked so the control system and/or perception system can act accordingly.

When the surface object information indicates that the surface object is the same surface object as previously tracked, the main object, at step 416, determines whether the location of the selected surface object relative to the main object has changed. For example, the location of the selected surface object relative to the main object can change when the location of the selected surface object and/or the location of the main object change from the last recorded location information. When the main object does not detect a change in the location of the selected surface object relative to the main object, the main object, at step 422, notifies the control system and/or perception system. When the main object detects a change in the location of the selected surface object relative to the main object, the main object determines the change in the location of the selected surface object relative to the main object (e.g., distance, angle, etc.) at step 418. At step 420, the main object stores the updated information on the location of the selected surface object relative to the main object, and notifies the control system and/or perception system of the updated information at step 422.

Thereafter, the main object repeats/performs the next cycle of the process 400 to continue tracking the surface object. The process 400 terminates (for the current selected surface object) and begins again when a new surface object is selected (i.e., new selected surface object is tracked). This may occur, for example, when the main object passes the current intersection and approaches the next intersection.

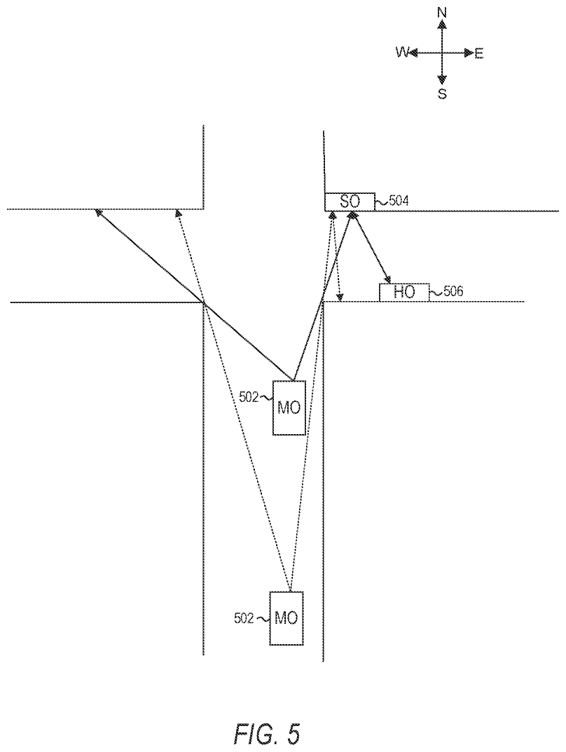

As stated above, the purpose of selecting and tracking a surface object is to be able to detect hidden objects. As shown in FIG. 5, when a main object 502 is far away from the corner, based on the location of a surface object 504, the perception system can only detect a hidden object that is within a close range to the corner. The range depends on the distance and angle between the main object 502 and the surface object 504. For example, when the surface object 504 is located on the northeast corner of an intersection, and when the main object 502 is located far from the intersection and to the right of the road, the perception system of the main object 502 can only transmit a light signal at a narrow angle to the surface object 504, which produces a narrow light refection range off the surface object 504. As a result, the perception system can only detect a hidden object that is within a close range to the corner when the main object 502 is located far from the intersection as shown in FIG. 5.

However, when the main object 502 is closer to the intersection, the view ahead of the main object 502 caught by the perception system will gradually extend and the perception system can transmit a light signal to the surface object 504 at a wider angle, which reflects off the surface object 504 at a wider angle to enable detection of the hidden object 506 further away from the corner. In addition, when the hidden object 506 is moving towards the same intersection as the main object 502, the closer the hidden object 506 is to the corner, the less time there is for a main object 502 to react. Therefore, in an embodiment, the main object 502 starts hidden object detection from a location right behind/close to a corner (i.e., starts looking for hidden objects that are close to the corner) and gradually moves further away from the corner as the main object 502 approaches the intersection.

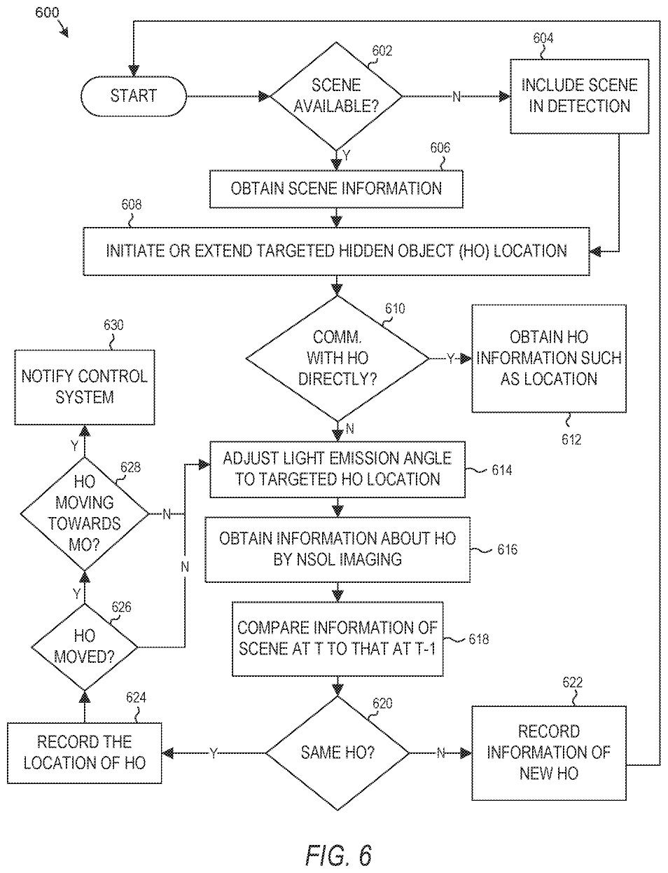

FIG. 6 is a flowchart illustrating a process 600 for detecting and tracking a hidden object in accordance with an embodiment of the present disclosure. In an embodiment, the process 600 is performed by a host system or perception system installed on a main object. The main object, at step 602, determines whether a scene of the environment of the main object is available. As stated above, the scene around the main object may have been created during the surface object selection process described in FIG. 2. When the scene around the main object is not available, the main object, at step 606, includes detection or creation of the scene as part of the process of detecting and tracking a hidden object. For example, in an embodiment, the scene can be created using the data and images captured by the perception system. In some embodiments, the scene can also be created using existing map data (e.g., data from Google Maps™). In an embodiment, the scene can also be used to identify static objects, which can be used as references to determine a location of a hidden object and/or when a hidden object is moving (i.e., distance between static object and hidden object changes). When a scene is already available, the main object obtains the available scene information at step 606 for use in detecting and tracking a hidden object.

At step 608, the main object initiates or extends the targeted hidden object location area (i.e., the area in which the hidden object may be located). At step 610, the main object determines whether the host system can communicate directly with the hidden object. In an embodiment, the host system attempts to communicate directly with the hidden object by broadcasting a wireless message using Wi-Fi® or using other wireless communications. When a communication channel between the host system and the hidden object is open, at step 612, the main object obtains or exchanges location information of the hidden object, and optionally other information such as, but not limited to, object type, velocity, and direction directly from the hidden object. In an embodiment, the host system can coordinate with the hidden object to ensure that the main object and the hidden object safely cross an intersection or other pathways.

When the host system cannot communicate directly with the hidden object, the main object, at step 614, adjusts the light emission angle from the main object to the surface object so the light is reflected towards the targeted hidden object location area. At step 616, the main object obtains data or information about the hidden object based on the NLOS imaging. As an example, the main object can use confocal NLOS imaging to detect the hidden object in the targeted hidden object location. For example, let τ(x′, y′, t) be the 3D volume of a measurement at surface (x′, y′) at time t. The hidden object can be reconstructed using the following equation:

$$τ ( {x}^{′} , {y}^{′} , t ) = \int \int {\int }_{Ω} \frac{1}{{r}^{4}} ρ ( x , y , z ) \cdot δ ( 2 \sqrt{{( {x}^{′} - x )}^{2} + {( {y}^{′} - y )}^{2} + {z}^{2}} - tc ) dx dy dz ,$$

where ρ is the albedo of the hidden object at (x, y, z), δ function represents the surface of a spatio-temporal four-dimensional hypercone, r=\sqrt{(x′−x)²+(y′−y)²+z²} is the distance function, and c is the speed of light.

At step 618, the main object compares the latest information of the scene around the main object (at time t) to the previously stored information of the scene around the main object (at time t−1). Using the comparison data from the previously stored scene, at step 620, the main object determines whether the hidden object is the same hidden object that was detected at time t−1. When the hidden object is not the same hidden object that was detected at time t−1 based on the comparison data from the previously stored scene, the main object, at step 622, the main object records the information on the new hidden object and initiates tracking of the new hidden object (i.e., returns to the beginning of the process 600). When the hidden object is the same hidden object that was detected at time t−1 based on the comparison data from the previously stored scene, the main object, at step 624, records the location of the hidden object.

Based on the location of the hidden object at time t compared the location of the hidden object at time t−1, the main object determines, at step 626, wherein the hidden object has moved. When the hidden object has moved, the main object, at step 628, the main object determines whether the hidden object is moving towards the main object (e.g., towards the same intersection as the main object). When the hidden object is determined to be moving towards the main object, the main object, at step 630, notifies the control system so appropriate actions can be taken by the control system. When the hidden object has not moved or is not moving towards the main object, the main object returns to step 614 and adjusts the light emission angle from the main object to the surface object to continue tracking the location of the hidden object.

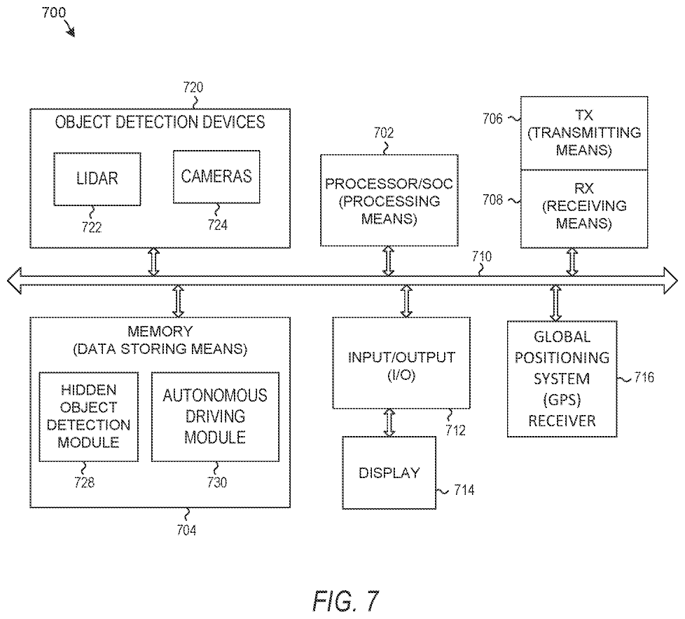

FIG. 7 is a schematic diagram illustrating a system 700 in accordance with an embodiment of the present disclosure. The system 700 may be used to implement various embodiments of a host system as disclosed herein.

The system 700 includes one or more processors 702 or other processing means to process instructions. In some embodiments, the processor 702 may be a central processing unit (CPU) chip having one or more processing cores, a field-programmable gate array (FPGA), an application specific integrated circuit (ASIC), and/or a digital signal processor (DSP). The processor 702 is communicatively coupled via a system bus 710 to the other components of the system 700. The processor 702 can be configured to execute instructions stored in memory 704. Thus, the processor 702 provides a means for performing any computational, comparison, determination, initiation, or configuration steps, or any other action, corresponding to the claims or disclosure when the appropriate instruction is executed by the processor.

The memory 704 or data storing means is configured to store instructions and various data. The memory 704 can be any type of, or combination of, memory components capable of storing data and/or instructions. For example, the memory 704 can include volatile and/or non-volatile memory such as read-only memory (ROM), random access memory (RAM), ternary content-addressable memory (TCAM), and/or static random-access memory (SRAM). The memory 704 can also include one or more disks, tape drives, and solid-state drives. In some embodiments, the memory 704 can be used as an over-flow data storage device or buffer to store programs when such programs are selected for execution, and to store instructions and data that are read during program execution. In some embodiments, the memory 704 can be memory that is integrated with the processor 702.

The system 700 includes a receiver unit (RX) 708 or receiving means for receiving data over a communication network. The system 700 also includes a transmitter unit (TX) 706 or transmitting means for transmitting data over a communication network. In some embodiments, the RX 708 and the TX 706 may be combined into a single transceiver unit. The RX 708 and the TX 706 may include one or more wired or wireless communication components such as, but not limited to, a Wi-Fi® component and/or near-field wireless communication component.

The system 700 includes a GPS receiver 716. The GPS receiver 716 obtains signals from GPS satellites. Based on the information contained in the signals, the system 700 can determine its precise location.

The system 700 can also include an Input/Output (I/O) component 712. The I/O component 712 enables the system 700 to receive input from one or more input devices such as, but not limited to, a touchscreen component, a keyboard, a mouse. The I/O component 712 can also be used to output information to a display 714. In some embodiments, the I/O component 712 may also include audio components for receiving input through a microphone and outputting audio through a speaker.

The system 700 also includes one or object detection devices 720 such as, but not limited to, a LiDAR system 722 and one or more cameras 724. The LiDAR system 722 could include one or more lasers or light emitting devices, and one or more sensors for detecting light.

In an embodiment, the memory 704 stores a hidden object detection module 728 and an autonomous driving module 730. The hidden object detection module 728 may include instructions and other data for implementing the processes for selecting a surface object in a dynamic environment as described in FIG. 2, for tracking a selected surface object as described in FIG. 4, and for tracking a hidden object as described in FIG. 6. The autonomous driving module 730 may include instructions and other data for providing autonomous driving capability for a vehicle. In some embodiments, the autonomous driving module 730 receives information from the hidden object detection module 728 (e.g., that a hidden object is moving towards the vehicle) to alter the autonomous driving instructions. The inclusion of the hidden object detection module 728 and the autonomous driving module 730 provides a technical improvement to the functionality of the system 700 by enabling the system 700 to detect hidden objects and alter the driving instructions to avoid the hidden object when necessary. Thus, the disclosed embodiments improve the safety of autonomous driving, as well as the various other implementations.

In some embodiments, the system 700 may include additional modules for performing any one of, or combination of, steps described in the embodiments. A module may include a particular set of functions, software instructions, or circuitry that is configured to perform a specific task. Further, any of the additional or alternative embodiments or aspects of the method, as shown in any of the figures or recited in any of the claims, are also contemplated to include similar modules.

Certain embodiments may be implemented as a system, an apparatus, a method, and/or a computer program product. The computer program product may include a computer readable storage medium (or media) having computer readable program instructions thereon for causing a processor to carry out aspects of the present disclosure. The computer readable storage medium may be a tangible device that can retain and store instructions for use by an instruction execution device.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. Additionally, in certain embodiments, instead of the processes described herein being performed by the main object, the processes can be performed on a remote system that communicates information or instructions to a main object.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of detecting hidden objects in a dynamic environment comprising:
selecting a surface object in the dynamic environment to reflect a light signal, wherein the dynamic environment comprises a main object;
transmitting the light signal from the main object to the surface object;
obtaining data based on a reflection of the light signal off of the surface object; and
analyzing the data to detect a hidden object that is not directly in a line of sight of the main object.

2. The method of claim 1, wherein the surface object is a moving object.

3. The method of claim 1, further comprising tracking a location of the surface object relative to the main object.

4. The method of claim 1, further comprising establishing direct communication with the hidden object.

5. The method of claim 1, wherein selecting the surface object comprises:
determining a surface object detection region;
removing objects that are not within the surface object detection region;
identifying potential surface objects within the surface object detection region; and
selecting the surface object from the potential surface objects.

6. The method of claim 1, wherein selecting the surface object comprises:
determining a criteria score for each of a plurality of criteria for each of a plurality of surface objects;
determining a total score based on the criteria score for each of the plurality of criteria for each of the plurality of surface objects; and
selecting the surface object from the plurality of surface objects based on the total score of each of the plurality of surface objects.

7. The method of claim 6, wherein the plurality of criteria for each of the plurality of surface objects comprises a brightness of the surface object, a flatness of the surface object, a velocity of the surface object, a size of the surface object, an angle between surface norm and light reflected from the surface object, and a distance between the main object and the surface object.

8. The method of claim 1, further comprising:
tracking a location of the hidden object; and
altering at least one of a speed or a course of the main object to avoid the hidden object.

9. A method of selecting a surface object in a dynamic environment to detect a hidden object, the method comprising:
analyzing a scene depicting an environment of a main object;
determining a surface object detection region within the scene; and
selecting a surface object within the surface object detection region.

10. The method of claim 9, further comprising removing objects that are not within the surface object detection region.

11. The method of claim 9, wherein determining the surface object detection region comprises estimating an area where the hidden object may be located.

12. The method of claim 9, wherein selecting the surface object within the surface object detection region comprises:
determining a criteria score for each of a plurality of criteria for each of a plurality of surface objects in the surface object detection region;
determining a total score based on the criteria score for each of the plurality of criteria for each of the plurality of surface objects in the surface object detection region; and
selecting the surface object from the plurality of surface objects in the surface object detection region based on the total score of each of the plurality of surface objects in the surface object detection region.

13. The method of claim 12, wherein the plurality of criteria for each of the plurality of surface objects comprises a brightness of the surface object, a flatness of the surface object, a velocity of the surface object, a size of the surface object, an angle between surface norm and light reflected from the surface object, and a distance between the main object and the surface object.

14. A system configured to detect hidden objects in a dynamic environment, the system comprising:
a memory storing instructions;
one or more processors coupled to the memory and configured to execute the instructions to cause the system to:
select a surface object in the dynamic environment to reflect a light signal, wherein the dynamic environment comprises a main object;
transmit the light signal from the main object to the surface object;
obtain data based on a reflection of the light signal off of the surface object; and
analyze the data to detect a hidden object that is not directly in a line of sight of the main object.

15. The system of claim 14, wherein the surface object is a moving object.

16. The system of claim 14, wherein the one or more processors execute the instructions to further cause the system to track a location of the surface object relative to the main object.

17. The system of claim 14, wherein the one or more processors execute the instructions to further cause the system to establish direct communication with the hidden object.

18. The system of claim 14, wherein the one or more processors execute the instructions to further cause the system to:
determine a surface object detection region;
remove objects that are not within the surface object detection region;
identify potential surface objects within the surface object detection region; and
select the surface object from the potential surface objects.

19. The system of claim 14, wherein the one or more processors execute the instructions to further cause the system to:
determine a criteria score for each of a plurality of criteria for each of a plurality of surface objects;
determine a total score based on the criteria score for each of the plurality of criteria for each of the plurality of surface objects; and
select the surface object from the plurality of surface objects based on the total score of each of the plurality of surface objects.

20. The system of claim 14, wherein the one or more processors execute the instructions to further cause the system to:
track a location of the hidden object; and
alter at least one of a speed or a course of the main object to avoid the hidden object.
